(19) United States
(12) Patent Application Publication
(10) Pub. No.: US 2014/0044205 A1
(43) Pub. Date: Feb. 13, 2014

(54) METHOD OF TRANSMITTING AND RECEIVING MIMO FEEDBACK INFORMATION IN WIRELESS COMMUNICATION SYSTEM, MOBILE STATION AND BASE STATION

(71) Applicants: Jeongki Kim, Anyang-si (KR); Wookbong Lee, Anyang-si (KR); Kiseon Ryu, Anyang-si (KR); Youngsoo Yuk, Anyang-si (KR)

(72) Inventors: Jeongki Kim, Anyang-si (KR); Wookbong Lee, Anyang-si (KR); Kiseon Ryu, Anyang-si (KR); Youngsoo Yuk, Anyang-si (KR)

(73) Assignee: LG ELECTRONICS INC., Seoul (KR)

(21) Appl. No.: 14/112,794

(22) PCT Filed: Mar. 20, 2012
(86) PCT No.: PCT/KR2012/001973

§ 371 Date: Oct. 18, 2013

Related U.S. Application Data
(60) Provisional application No. 61/477,595, filed on Apr. 20, 2011.
(60) Provisional application No. 61/483,716, filed on May 8, 2011.
(60) Provisional application No. 61/486,782, filed on May 17, 2011.
(60) Provisional application No. 61/505,119, filed on Jul. 7, 2011.

(30) Foreign Application Priority Data
Mar. 6, 2012 (KR) 10-2012-0022644

(51) Int. Cl. H04B 7/04

(52) U.S. Cl. CPC H04B 7/0417
USPC 375/260

(57) ABSTRACT

A method of transmitting an MIMO (multiple input multiple output) feedback information, which is transmitted by a mobile station in a wireless communication system, is disclosed. The present invention includes sending a ranging request message to a base station and receiving a ranging response message from the base station in response to the ranging request message, wherein the mobile station comprises a fixed M2M (machine to machine) device and wherein the ranging request message contains the MIMO feedback information.

### TECHNICAL FIELD

The present invention relates to a broadband wireless mobile communication system, and more particularly, to a method of transmitting and receiving MIMO feedback information for a mobile station in a broadband wireless communication system.

### BACKGROUND ART

Generally, MIMO (multiple input multiple output) scheme means the scheme of increasing system capacity in a manner that a base station or a mobile station simultaneously transmits several data streams (or layers) spatially using at least two transmitting/receiving antennas. The MIMO scheme includes transmit diversity, spatial multiplexing or beamforming.

In the transmit diversity scheme, the same data information is transmitted via several transmitting antennas, thereby implementing highly reliable data transmission advantageously without channel related feedback information from a receiver. The beamforming is used to increase a reception SINR (signal to interference plus noise ratio) of a receiver in a manner of multiplying each transmitting antenna by an appropriate weight. In the beamforming, since uplink/downlink channel is generally independent in FDD (frequency division duplexing) system, highly reliable channel information necessary to acquire an appropriate beamforming gain. Hence, the beamforming receives a separate feedback from a receiver and then uses the received separate feedback.

The spatial multiplexing scheme may be categorized into a single user spatial multiplexing scheme and a multi-user spatial multiplexing scheme. The single user spatial multiplexing scheme is called SM (spatial multiplexing) or SU-MIMO (single user MIMO). According to the spatial multiplexing scheme, a plurality of antenna resources of a base station are entirely allocated to a single user (or mobile station) and capacity of MIMO channel increases in proportion to the number of antennas. Meanwhile, the multi-user spatial multiplexing scheme is called SDMA (spatial divisional multiple access) or MU-MIMO (multi-user MIMO). According to the multi-user spatial multiplexing scheme, a plurality of antenna resources or radio space resources of a base station are distributed to multiple users (mobile stations).

In case of using the MIMO scheme, there are a single codeword (SCW) method of transmitting N simultaneously-transmitted data streams (or layers) using a single channel encoding block and a multiple codeword (MCW) method of transmitting N data streams using M channel encoding blocks (M≦N). In this case, each of the channel encoding blocks creates an independent codeword (CW) and each codeword is designed to enable independent error detection.

Machine-to-machine (hereinafter abbreviated M2M) communication literally means a communication between one electronic device and another electronic device. In a broad sense, M2M communication may mean a wire/wireless communication between electronic devices or a communication between a human-controllable device and a machine. Recently, the M2M communication generally indicates a communication between electronic devices, i.e., a device-to-device wireless communication performed without human involvement.

In the early 1990's, in which the concept of the M2M communication has been initially introduced, the M2M communication has been recognized as remote control or telematics or the like and derivative markets of the M2M communication were very limitative. Yet, the M2M communication has grown rapidly for past few years and has become the globally noteworthy markets. Specifically, in POS (point of sales) and security related application markets, the M2M communication has considerably influence on such field as fleet management, remote monitoring of machinery and equipment, smart meter for auto-measurement of operating time, consumed heat or electricity quantity on construction machinery equipment and the like. M2M communication in the future will be further utilized for various usages in connection with a small-scale output communication solution such as conventional mobile communication, wireless high-speed interne, Wi-Fi, ZigBee and the like and may lay the foundation of expansion to B2C (business to consumer) markets instead of being confined to B2B (business to business) markets.

In the era of M2M communication, every machine equipped with SIM (subscriber identify module) card enables data transmission and reception and is capable of remote management and control. For instance, as M2M communication technology is usable for numerous devices and equipment including vehicles, trucks, containers, autovending machines, gas tanks and the like, its application fields may reach far and wide.

According to a related art, since mobile stations are managed by individual unit in general, a communication between a base station and a mobile station is usually performed by a one-to-one communication scheme. Assuming that numerous M2M devices communicate with a base station by the one-to-one communication scheme, network may be overloaded due to the occurrence of signaling between the base station and each of the numerous M2M devices.

### DISCLOSURE OF INVENTION

### Technical Problem

Accordingly, the present invention is directed to a method of transmitting and receiving MIMO feedback information for a mobile station in a broadband wireless communication system that substantially obviates one or more of the problems due to limitations and disadvantages of the related art.

One object of the present invention is to provide an apparatus and method for an M2M (machine to machine) device to perform a communication with a base station.

Another object of the present invention is to provide an apparatus and method for a base station to perform a communication with an M2M (machine to machine) device.

Another object of the present invention is to provide an M2M (machine to machine) device that performs a communication with a base station.

A further object of the present invention is to provide a base station that performs a communication with an M2M (machine to machine) device.

Technical tasks obtainable from the present invention are non-limited the above-mentioned technical task. And, other unmentioned technical tasks can be clearly understood from the following description by those having ordinary skill in the technical field to which the present invention pertains.

### Solution to Problem

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a method of transmitting an MIMO (multiple input multiple output) feedback information, which is transmitted by a mobile station in a wireless communication system, according to one embodiment of the present invention includes the steps of sending a ranging request message to a base station and receiving a ranging response message from the base station in response to the ranging request message, wherein the mobile station comprises a fixed M2M (machine to machine) device and wherein the ranging request message contains the MIMO feedback information.

To further achieve these and other advantages and in accordance with the purpose of the present invention, a mobile station, which transmits an MIMO (multiple input multiple output) feedback information in a wireless communication system, according to another embodiment of the present invention includes a receiver, a transmitter, and a processor configured to control the receiver and the transmitter, the processor controlling the transmitter to send a ranging request message to a base station, the controller controlling the receiver to receive a ranging response message in response to the ranging request message, wherein the mobile station comprises a fixed M2M (machine to machine) device and wherein the ranging request message contains the MIMO feedback information.

To further achieve these and other advantages and in accordance with the purpose of the present invention, a method of receiving an MIMO (multiple input multiple output) feedback information, which is received from a mobile station by a base station in a wireless communication system, according to another embodiment of the present invention includes the steps of receiving a ranging request message from the mobile station and sending a ranging response message to the mobile station using the ranging request message, wherein the mobile station comprises a fixed M2M (machine to machine) device and wherein the ranging request message contains the MIMO feedback information.

To further achieve these and other advantages and in accordance with the purpose of the present invention, a base station, which receives an MIMO (multiple input multiple output) feedback information from a mobile station in a wireless communication system, according to a further embodiment of the present invention includes a receiver, a transmitter, and a processor configured to control the receiver and the transmitter, the processor controlling the receiver to receive a ranging request message from the mobile station, the processor controlling the transmitter to send a ranging response message to the mobile station using the ranging request message, wherein the mobile station comprises a fixed M2M (machine to machine) device and wherein the ranging request message contains the MIMO feedback information.

Preferably, the MIMO feedback information includes a new MIMO feedback information obtained by newly measuring a downlink channel from the base station.

Preferably, the MIMO feedback information includes the MIMO feedback information most recently transmitted by the mobile station to the base station.

More preferably, the MIMO feedback information includes an MFM bitmap and an information including at least one selected from the group consisting of CQI (Channel Quality Indicator), STC (Space Time Coding) and PMI (Preferred Matrix index).

It is to be understood that both the foregoing general description and the following detailed description are exemplary and explanatory and are intended to provide further explanation of the invention as claimed.

### Advantageous Effects of Invention

According to various embodiments of the present invention, when a mobile station in idle mode reenters a network, a downlink MCS (modulation and coding scheme) and an MIMO mode of the mobile station can be quickly applied.

According to the present invention, an M2M device may be able to quickly perform network entry/reentry on a base station by a network entry/reentry method.

According to the present invention, unnecessary overhead of downlink control information can be reduced.

According to the present invention, a resource of a feedback channel can be saved while a transmission rate of a transmitting stage of a related art is maintained with negligible differences. And, an optimal transmission rate of a transmitting stage can be implemented.

Therefore, the present invention provides an enhanced AMC scheme, thereby enhancing performance degradation of an AMC scheme due to inaccuracy and unnecessary feedback transmission of channel quality information in an environment having user's mobility.

Effects obtainable from the present invention may be non-limited by the above mentioned effect. And, other unmentioned effects can be clearly understood from the following description by those having ordinary skill in the technical field to which the present invention pertains.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic diagram for configurations of an M2M device and a base station according to one embodiment of the present invention;

FIG. 2 is a flowchart of a process for performing a network entry procedure of a mobile station according to one embodiment of the present invention;

FIG. 3 is a flowchart of a process for performing a network entry procedure of a base station according to one embodiment of the present invention;

FIG. 4 is a flowchart of a process for performing a network entry procedure of a mobile station according to another embodiment of the present invention;

FIG. 5 is a flowchart of a process for performing a network entry procedure of a mobile station according to another embodiment of the present invention;

FIG. 6 is a flowchart of a process for performing a network entry procedure of a mobile station according to another embodiment of the present invention;

FIG. 7 is a flowchart of a process for performing a network entry procedure of a mobile station according to another embodiment of the present invention;

FIG. 8 is a flowchart of a process for performing a network entry procedure of a mobile station according to another embodiment of the present invention;

FIG. 9 is a flowchart of a process for performing a network entry procedure of a mobile station according to another embodiment of the present invention;

FIG. 10 is a flowchart of a process for performing a network entry procedure of a mobile station according to a further embodiment of the present invention;

FIG. 11 is a flowchart of a process for performing a network entry procedure between a mobile station and a base station according to one embodiment of the present invention;

FIG. 12 is a flowchart of a process for performing a network entry procedure between a mobile station and a base station according to another embodiment of the present invention; and

FIG. 13 is a flowchart of a process for performing a network entry procedure between a mobile station and a base station according to a further embodiment of the present invention.

### MODE FOR THE INVENTION

Reference will now be made in detail to the preferred embodiments of the present invention, examples of which are illustrated in the accompanying drawings. In the following detailed description of the invention includes details to help the full understanding of the present invention. Yet, it is apparent to those skilled in the art that the present invention can be implemented without these details. Detailed description disclosed together with the accompanying drawings is intended to explain not a unique embodiment of the present invention but an exemplary embodiment of the present invention.

Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same or like parts.

Besides, in the following description, assume that a terminal is a common name of such a mobile or fixed user stage device as a user equipment (UE), a mobile station (MS), an advanced mobile station (AMS), a machine-to-machine (M2M) device and the like and that a base station is a common name of such a random node of a network stage communicating with a terminal as a Node B, an eNode B, a base station (BS), an access point (AP) and the like. For instance, although the following descriptions in this specification are made on the basis of IEEE 802.16e/m, they are applicable to other communication systems such as 3GPP LTE system, LTE-A system and the like.

In the following description, a communication between M2M devices may mean an information exchange performed between mobile stations or between a base station and each of mobile stations without human involvement. Hence, the M2M device may mean a mobile station capable of supporting the above-mentioned M2M device communication. An access service network for an M2M service may be defined as an M2M ASN (M2M access service network) and a network entity performing communications with M2M devices may be named an M2M server. In particular, the M2M server activates an M2M application and provides an M2M-specific service for at least one or more M2M devices. An M2M feature indicates a feature of an M2M application. And, at least one feature may be necessary to provide an application. An M2M device group may mean a group of M2M devices that share at least one common feature with each other.

The devices performing communications by M2M scheme may be named M2M devices, M2M communication devices and the like in various ways. And, the number of the devices will increase gradually as the number of machine application types does. The currently discussed machine application types may include (1) security, (2) public safety, (3) tracking and tracing, (4) payment, (5) healthcare, (6) remote maintenance and control, (7) metering, (8) consumer device, (9) POS (Point Of Sales) and fleet Management in security related market, (10) M2M communication of vending machine (11) smart meter for plant and machinery remote monitoring, operating time measurement on measurement on construction plant and machinery and auto-measurement of consumed heat or electricity quantity on construction plant and machinery, (12) surveillance video communication and the like, by which the machine application types may be non-limited. And, there are ongoing discussions on other machine application types.

As the machine application types are diversified, the number of the M2M communication devices can be increased more rapidly than that of general mobile communication devices. According to properties of the M2M device, traffic may be transmitted to a base station periodically by long-term periods or data transmission may be performed in case that an event is triggered. In particular, while an M2M device mostly stays in idle mode, if a period comes up or an event is triggered, the M2M device wakes up to enter an active state. According to properties of M2M devices, a prescribed one (e.g., a metering machine, a vending machine, etc.) of the M2M devices may have low mobility or no mobility. If a prescribed M2M device has considerably low mobility or does not have mobility at all, it may mean that the corresponding M2M device is stationary in the long term. An M2M communication system may be able to simplify or optimize mobility-related operations for a specific M2M application related to such an M2M device having a stationary location as an M2M device for secured access and surveillance, an M2M device for public safety, an M2M device for payment, an M2M device for remote maintenance and control, an M2M device for metering and the like. Another M2M device (e.g., an M2M device related to such an M2M application as tracking and tracing, fleet management, etc.) may have high mobility. As the number of application types for the M2M devices keeps growing increasingly, numerous M2M devices will exist in the same base station. Therefore, it may be necessary for a base station to smoothly support random accesses of numerous M2M devices staying in idle state.

In the following description, an embodiment of the present invention is explained with reference to a case of applying M2M communication to IEEE 802.16e/m, by which the present invention may be non-limited. And, an embodiment of the present invention is applicable to such a different system as 3GPP LTE system and the like in the same manner.

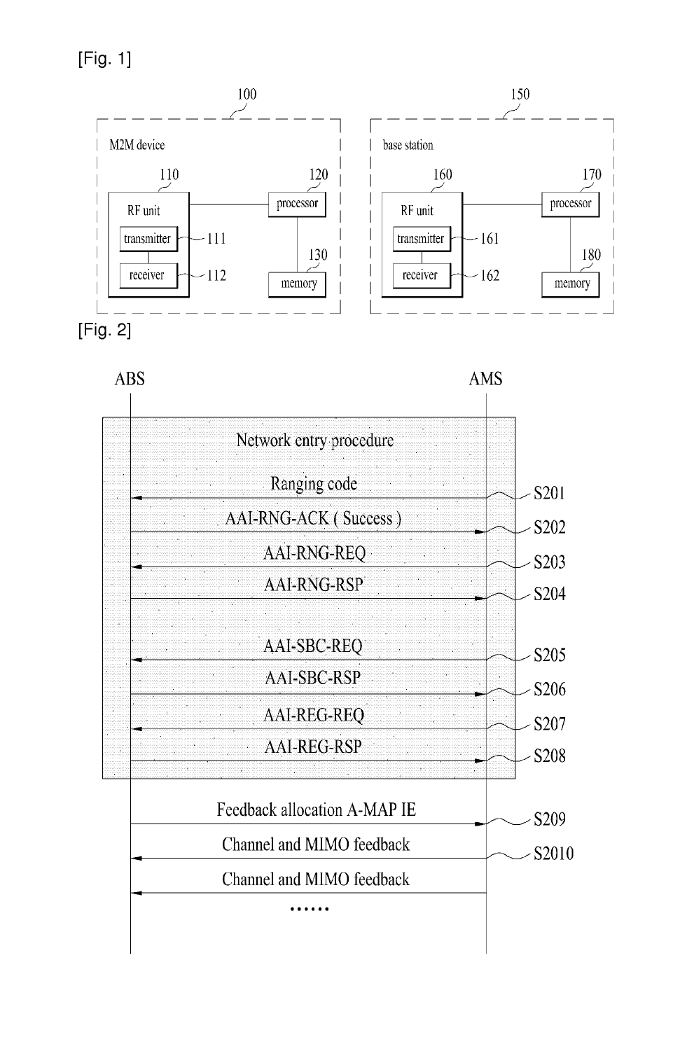

FIG. 1 is a schematic diagram for configurations of an M2M device and a base station according to one embodiment of the present invention.

Referring to FIG. 1, an M2M device 100, which may be named an M2M communication device but will be named as an M2M device in the following, may include an RF unit 110, a processor 120 and a memory 130. In this case, the memory 130 is optional component. And, a base station 150 may include an RF unit 160, a processor 170 and a memory 180. In this case, the memory 180 is an optional component. The RF unit 110/160 may include a transmitter 111/161 and a receiver 112/162. For example of the M2M device 100, the transmitter 111 is configured to transmit signals to the base station 150 and other M2M devices. And, the receiver 112 is configured to receive signals from the base station 150 and other M2M devices. The process 120 is functionally connected to each of the transmitter 111 and the receiver 112 to control a process for the transmitter 111 and the receiver 112 to transceive signals with other devices. The processor 120 performs various kinds of processings on a signal to transmit and then transfers the processed signal to the transmitter 111. And, the processor 120 may be able to perform processing on a signal received by the receiver 112. If necessary, the processor 120 may control information contained in an exchanged message to be saved in the memory 130. The above-configured M2M device 100 may perform various methods according to embodiments of the present invention mentioned in the following description. Besides, the M2M device 100 may further include various kinds of additional components (not shown in FIG. 1) according to its machine application type. In case that the corresponding M2M device 100 is provided for the smart meter, it may further include an additional configuration for power measurement and the like. This power measuring operation may be under the control of the processor 120 shown in FIG. 1 or a separately configured processor (not shown in the drawing).

Although FIG. 1 shows a case that a communication is performed between the M2M device 100 and the base station 150, an M2M communication method according to the present invention may be performed between M2M devices. In particular, each of the M2M devices may have the same device configurations shown in FIG. 1 to perform various methods according to embodiments of the present invention mentioned in the following description.

The transmitter 161 of the base station 150 is configured to transmit signals to another base station, an M2M server and M2M devices. And, the receiver 162 of the base station 150 is configured to receive signals from another base station, an M2M server and M2M devices. The process 170 is functionally connected to each of the transmitter 161 and the receiver 162 to control a process for the transmitter 161 and the receiver 162 to transceive signals with other devices. The processor 170 performs various kinds of processings on a signal to transmit and then transfers the processed signal to the transmitter 161. And, the processor 170 may be able to perform processing on a signal received by the receiver 162. If necessary, the processor 170 may control information contained in an exchanged message to be saved in the memory 180. The above-configured base station 150 may perform various methods according to embodiments of the present invention mentioned in the following description.

The processor 120 of the M2M device 100 directs operations (e.g., control, adjustment, management, etc.) in the M2M device 100. The processor 170 of the base station directs operations (e.g., control, adjustment, management, etc.) in the base station 150. The processor 120/170 may be connected to the memory 130/180 configured to store program codes and data. The memory 130/180 is connected to the processor 120/170 to store operating systems, applications and general files.

The processor 120/170 may be named one of a controller, a microcontroller, a microprocessor, a microcomputer and the like. Moreover, the processor 120/170 may be implemented by hardware, firmware, software or a combination thereof. In case of implementing an embodiment of the present invention using hardware, the processor 120/170 may be provided with such a configuration to perform the present invention as ASICs (application specific integrated circuits), DSPs (digital signal processors), DSPDs (digital signal processing devices), PLDs (programmable logic devices), FPGAs (field programmable gate arrays), and the like.

In case of implementing embodiments of the present invention using firmware or software, the firmware or software may be configured to include modules, procedures, and/or functions for performing the functions or operations of the present invention. And, the firmware or software configured to perform the present invention may be driven by the processor 120/170 in a manner of being installed at the processor 120/170 or being saved in the memory 130/180.

As mentioned in the foregoing description, in case that the M2M communications are rapidly spreading across a wider range, overheads due to the communications between the M2M devices or the communications between the base station and the M2M devices may cause problems. In order to efficiently solve the overhead problems in consideration of properties of the M2M communication system, it may be necessary to efficiently perform resource allocations of M2M devices. A method for reducing unnecessary MAP overhead is proposed as follows.

AMC (adaptive modulation and coding) scheme is a scheme of dynamically changing an MCS (modulating and coding scheme) to keep up with a channel status. In general, a receiver observes a channel status, selects an appropriate MCS, and then transmits the MCS to a transmitter side. According to the AMC scheme, it may be able to compensate for variation of a channel quality attributed to multi-path fading or user's movement to some extent. One of general criteria used to determine MCS is to estimate a channel quality. By estimating a channel quality, an MCS optimal to maximize a transmission rate under target QoS (quality of service) restriction is selected. In this case, the channel quality normally uses a signal-to-noise ratio (SNR).

In general, such a scheme of raising performance of a system by feedback as an AMC scheme and the like may show the best performance in case of receiving feedback information on a channel statue, a moving speed of a user and the like from a receiving stage each time a data transmission is performed. Yet, if the feedback information is transmitted on each data transmission, a corresponding feedback channel may be overloaded. If the feedback channel is overloaded, it may be unable to effectively distribute channels resources in a multiple access system.

In order to solve this problem, the related art has proposed a method of performing a feedback by a preset period without considering a channel situation. Yet, despite that a channel or a user's moving speed is not considerably changed, this method should calculate and transmit feedback information if a predetermined period comes up. Hence, loads on a receiving stage and a feedback channel become heavier unnecessarily. Moreover, according to the related art method, despite that a channel or a user's moving speed considerably changes, since it is unable to receive feedback information until a predetermined period comes up, a previous feedback information is used to cause degradation of a system takes.

Therefore, compared to the related art feedback method, requested is a method of effectively reducing a quantity of fed-back information despite maintaining a throughput of a transmitting stage.

FIG. 2 is a flowchart of a process for performing a network entry (or reentry) procedure between a mobile station and a base station in a conventional IEEE 802.16m system according to one embodiment of the present invention.

In FIG. 2, after a mobile station has performed a network entry or reentry, a base station transmits feedback allocation A-MAP IE or feedback polling A-MAP IE to the mobile station to allocate a fast feedback control channel necessary for the mobile station. The mobile station then transmits feedback information related to MIMO (multiple input multiple output) and a channel status via the feedback control channel. Using the MIMO information received from the mobile station, when the base station allocates a resource, the base station determines a downlink (DL) MIMO mode or MCS and then sets the determined DL MIMO mode or MCS to an appropriate value. The base station allocates an uplink control channel (UL CCH) as a feedback channel using the feedback allocation A-MAP IE and allocates a header of an uplink shared channel (UL SCH) or uplink control channel (UL CCH) as a feedback channel using the feedback polling A-MAP IE.

Referring to FIG. 2, a mobile station transmits an initial ranging or a handover ranging to a base station (e.g., the following description is made on the assumption that the mobile station transmits the initial ranging). In this case, the initial ranging is a process for the mobile station to acquire a precise timing offset with the base station and to adjust a transmission power in an early stage. In general, if a power of a mobile station it turned on, the mobile station acquires a downlink synchronization from a downlink preamble signal. Subsequently, the mobile station performs an initial ranging to adjust an uplink timing offset and a transmission power. The mobile station selects a ranging channel, selects a ranging preamble code from an initial ranging domain, and then transmits the selected ranging preamble code to the base station via the selected ranging channel [S201].

Subsequently, the base station may be able to send an acknowledgement response message to the mobile station in response to the initial or handover ranging transmission from the mobile station [S202]. In this case, the response message may be defined as a ranging acknowledgement (AAI-RNG-ACK) message. In particular, the ranging acknowledgement (AAI-RNG-ACK) message is the message that provides a response indicating that all ranging preamble codes have been successfully received and detected in all ranging opportunities. The base station may be able to transmit the ranging acknowledgement (AAI-RNG-ACK) message to the mobile station in a manner that three kinds of available ranging statuses for the initial or handover ranging are contained in the ranging acknowledgement (AAI-RNG-ACK) message. In this case, the three kinds of the available ranging statuses contained in the ranging acknowledgement (AAI-RNG-ACK) message include a status ‘continue’, a status ‘success’ and a status ‘abort’.

If the ranging status for the initial or handover ranging is the status ‘success’, the base station may be able to transmit information required for transmitting a ranging request (AAI-RNG-REQ) message to the mobile station via CDMA allocation A-MAP IE. In particular, the base station provides the mobile station with uplink resource allocation information for a ranging request transmission and the like via the CDMA allocation A-MAP IE message. If the mobile station transmits a ranging to the base station, the base station may be able to transmit uplink resource information allocated for the ranging request message transmission to the mobile station via a resource index filed and the like. If the mobile station receives the CDMA allocation A-MAP IE from the base station, the mobile station sends a message for requesting a ranging to the base station [S203]. The mobile station may be then able to receive a ranging response message from the base station in response to the ranging request message [S204]. The mobile station sends an SBC-REQ message to the base station and may be then able to receive an SBC-RSP message from the base station [S205, S206]. The mobile station sends a registration request (REG-REQ) message to the base station and may be then able to receive a registration response (REG-RSP) message from the base station [S207, S208]. The base station provides the mobile station with uplink resource allocation information for the ranging request transmission and the like via the CDMA allocation A-MAP IE message [S209]. The mobile station may be then able to transmit channel and MIMO feedback information to the base station [S210].

Yet, in an M2M system, most of M2M devices including a smart metering, a vending machine and the like may exist at fixed locations without moving. A channel status of each of the M2M devices in the fixed state barely changes but maintains mostly uniform. Thus, if there is almost no channel change of a mobile station, MCS (DIUC/UIUC (downlink interval usage code/uplink interval usage code) or MIMO information used by the mobile station may not be changed in the long term. In doing so, if the base station allocates a resource for periodic feedback to the fixed mobile station via the feedback allocation A-MAP IE or the feedback polling A-MAP IE, it may cause a problem that an unnecessary feedback overhead is increased. And, it may also cause a problem that scheduling efficiency is lowered. This is because the base station is unable to set the MIMO mode of the mobile station until the mobile station uploads the channel and MIMO feedback information to the base station by receiving the allocation of the feedback channel.

Therefore, a method of reducing MAP overhead unnecessary for a case of allocating resources to fixed mobile stations is requested. In the following description, an embodiment of the present invention is explained with reference to a case of applying M2M communication to IEEE 802.16m system.

Referring to FIG. 2, after the mobile station has performed the network entry or reentry via the ranging process, the mobile station transmits feedback information related to the MIMO (multiple input multiple output) and the channel status to the base station via the allocated feedback channel.

Yet, in case of a fixed M2M mobile station, since a channel status is barely changed but mostly maintained uniform, the resource allocation for periodic feedback causes unnecessary overhead increase. Therefore, according to the present invention, when a network entry of a mobile station is performed, MIMO feedback information can be transmitted in a manner of being contained in a ranging request message.

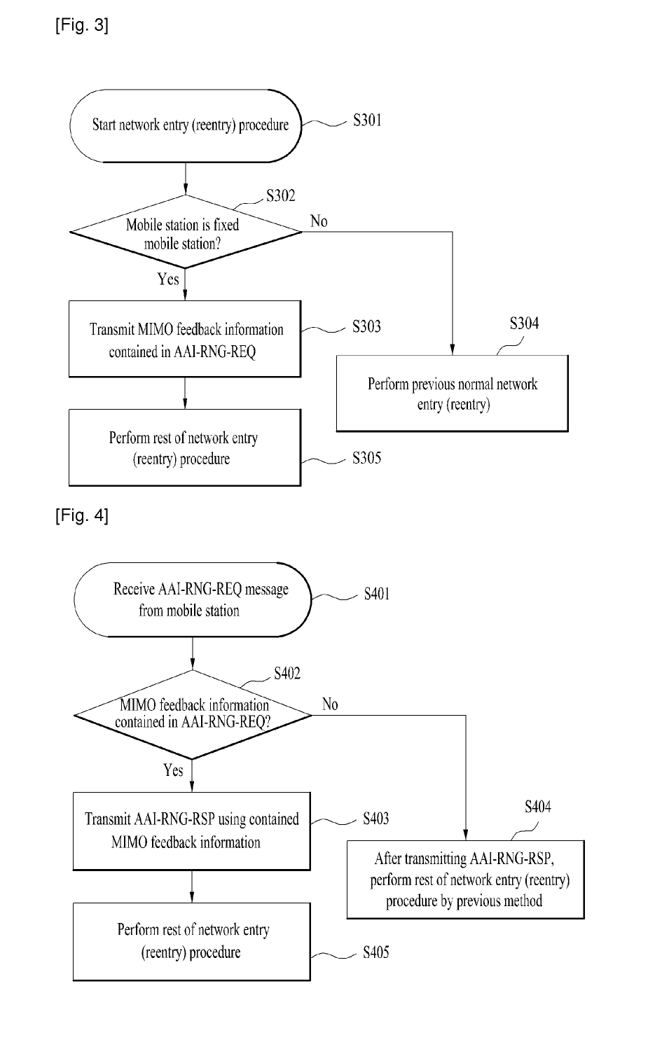

FIG. 3 is a flowchart of a feedback process when a fixed M2M device performs a network entry (or reentry) according to one embodiment of the present invention.

Referring to FIG. 3, a method of increasing scheduling efficiency on a manner of using an MIMO mode of an M2M device quickly using a corresponding feedback information is provided. For the present invention, when a mobile station performs a network entry (or reentry), the mobile station transmits MIMO feedback information to a base station in a manner that the MIMO feedback information is contained in a ranging request (AAI-RNG-REQ) message that is sent to the base station. In this case, the MIMO feedback information includes information indicating that the mobile station is able to support which MIMO feedback mode (MFM) and information containing at least one of CQI (Channel Quality Indicator), STC (Space Time Coding) and PMI (Preferred Matrix Index). If the base station receives the ranging request (AAI-RNG-REQ) message containing the MIMO feedback information from the fixed mobile station, the base station appropriately sets MCS and MIMO information for a downlink data (or burst) transmission based on the information received from the mobile station. In particular, when AAI-RNG-RSP is transmitted in response to the ranging request (AAI-RNG-REQ) message, the base station appropriately sets the MCS and MIMO information for the corresponding burst transmission using the information received from the mobile station. In order to set the MCS and MIMO information for the burst containing AAI-RNG-RSP, the MIMO information and the MCS information are transmitted in a manner of being contained in CDMA-allocation A-MAP IE. Moreover, if the base station determines that the information received from the mobile station is not appropriate, after the mobile station has completed the network entry (or reentry), the base station allocates an uplink feedback channel to the mobile station using feedback allocation A-MAP IE or feedback polling A-MAP IE.

Referring to FIG. 3, when a mobile station performs a network entry (or reentry) [S301], if the corresponding mobile station is a fixed mobile station [Yes, S 302], the mobile station transmits MIMO feedback information (e.g., Wideband CQI, Wideband STC, Wideband PMI (Preferred Matrix Index), etc.) to a base station in a manner that the MIMO feedback information is contained in a ranging request (AAI-RNG-REQ) message [S303]. The mobile station receives a ranging response (AAI-RNG-RSP) message from the base station and then performs the rest of the network entry (or reentry) procedure [S305]. If the corresponding mobile station is not a fixed mobile station [No, S302], it may be able to perform a previous normal network entry (or reentry) procedure [S304].

FIG. 4 is a flowchart of a feedback performing process when a base station performs a network entry procedure of a mobile station according to another embodiment of the present invention.

Referring to FIG. 4, when a base station receives a ranging request (AAI-RNG-REQ) message from a mobile station [S401], if MIMO feedback information is contained in the ranging request (AAI-RNG-REQ) message [Yes, S402], the base station sends a ranging response (AAI-RNG-RSP) message using the contained MIMO feedback information [S403] and performs the rest of the network entry procedure [S405]. If MIMO feedback information is not contained in the ranging request (AAI-RNG-REQ) message [No, S402], the base station sends a ranging response (AAI-RNG-RSP) message by a conventional method and then performs the rest of the network entry (or reentry) procedure [S404].

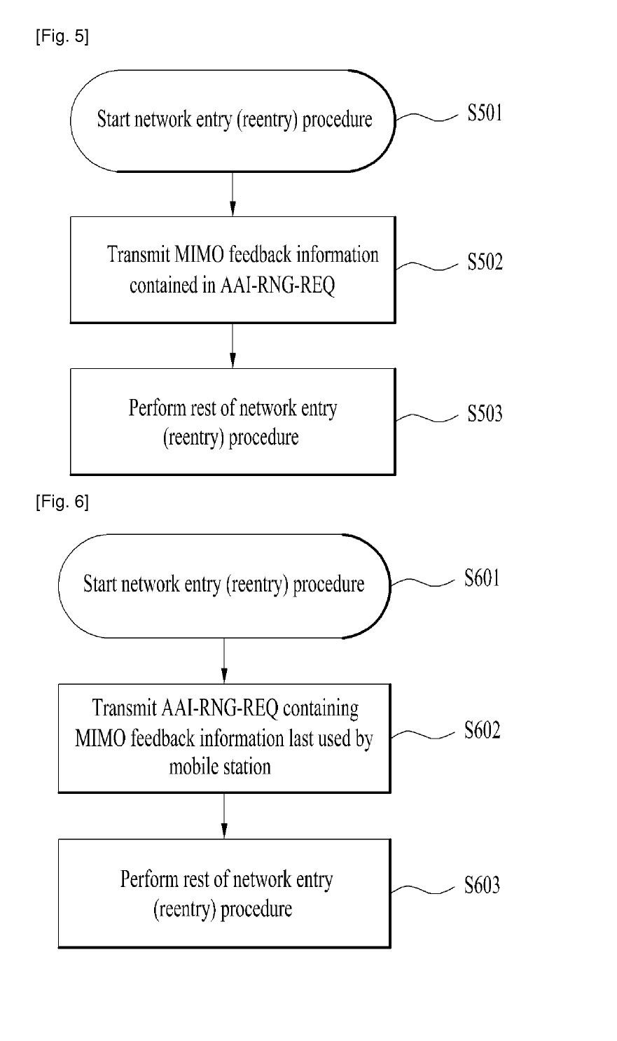

FIG. 5 is a flowchart of a feedback performing process when an M2M device performs a network entry (or reentry) procedure according to another embodiment of the present invention.

Referring to FIG. 5, in a network entry (or reentry) procedure [S501], a mobile station sends a ranging request (AAI-RNG-REQ) message containing MIMO feedback information irrespective of a fixed mobile station or a mobile station [S502] and then waits for a ranging response (AAI-RNG-RSP) message from a base station. Thereafter, the mobile station performs the rest of the network entry (or reentry) procedure [S503].

FIG. 6 is a flowchart of a feedback performing process when an M2M device performs a network entry (or reentry) procedure according to another embodiment of the present invention.

Referring to FIG. 6, in a network entry (or reentry) procedure [S601], MIMO feedback information contained in a ranging request (AAI-RNG-REQ) message by the mobile station irrespective of a fixed mobile station or a mobile base station corresponds to feedback information sent last to a base station by the mobile station. The mobile station sends the ranging request (AAI-RNG-REQ) message containing a last used feedback information to the base station [S602] and then waits for a ranging response (AAI-RNG-RSP) message from the base station. Thereafter, the mobile station performs the rest of the network entry (or reentry) procedure [S603].

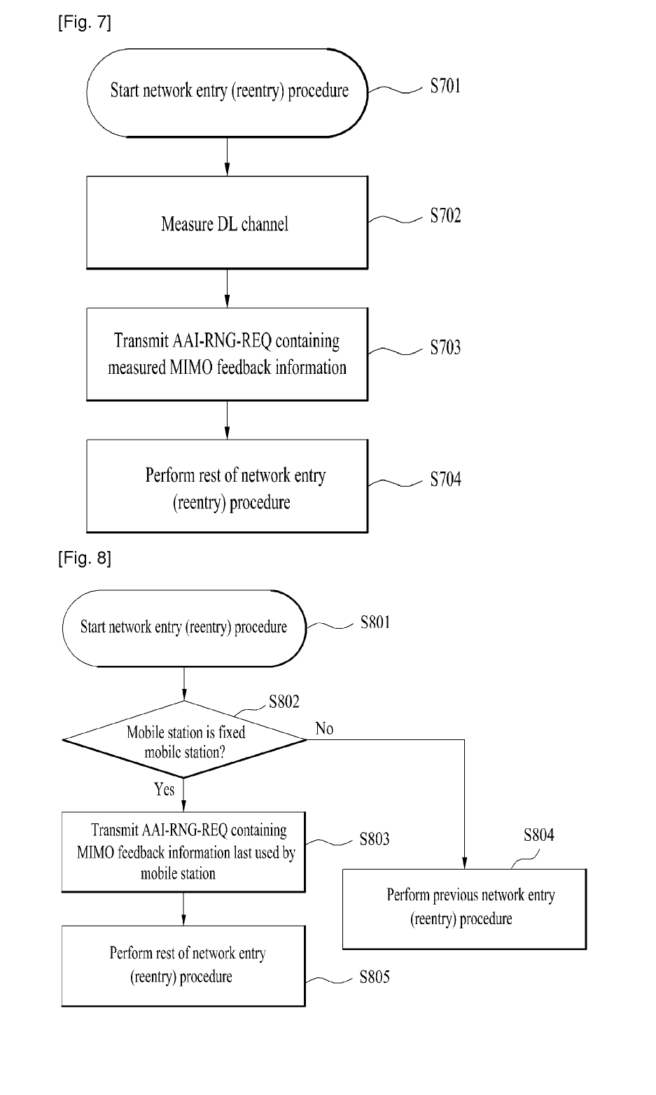

FIG. 7 is a flowchart of a feedback performing process when an M2M device performs a network entry (or reentry) procedure according to another embodiment of the present invention.

Referring to FIG. 7, when a mobile station performs a network entry (or reentry) [S701], the mobile station measures a downlink channel [S702] and then sends a ranging request (AAI-RNG-REQ) message containing a measured MIMO feedback information [S703]. The mobile station waits for a ranging response (AAI-RNG-RSP) message from a base station. Thereafter, the mobile station performs the rest of a network entry (or reentry) procedure [S704].

FIG. 8 is a flowchart of a feedback performing process when an M2M device performs a network entry (or reentry) procedure according to another embodiment of the present invention.

Referring to FIG. 8, a mobile station initiates a network entry (or reentry) procedure [S801]. Only if the mobile station is a fixed mobile station [yes, S802], the mobile station sends a ranging request (AAI-RNG-REQ) message containing a last used MIMO feedback information [S803] and then waits for a ranging response (AAI-RNG-RSP) message from a base station. Thereafter, the mobile station performs the rest of a network entry (or reentry) procedure [S805]. If the mobile station is not the fixed mobile station [no, S802], the mobile station performs a previous normal network entry (or reentry) procedure [S804].

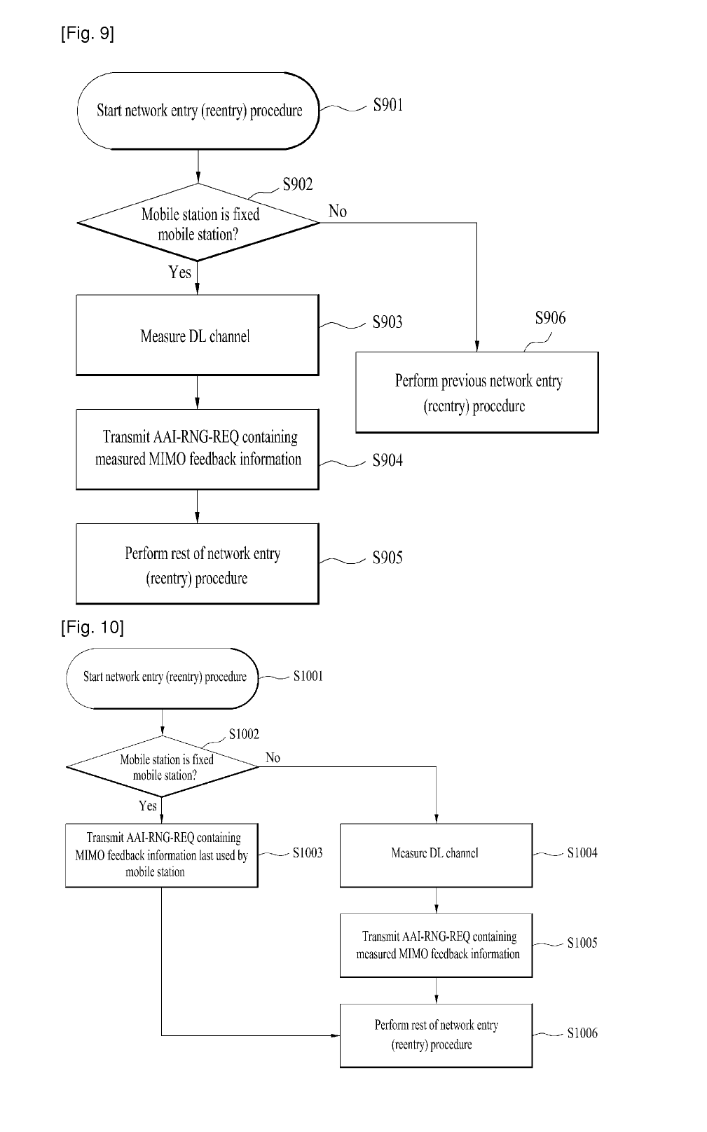

FIG. 9 is a flowchart of a feedback performing process when an M2M device performs a network entry (or reentry) procedure according to another embodiment of the present invention.

Referring to FIG. 9, a mobile station initiates a network entry (or reentry) procedure [S901]. Only if the mobile station is a fixed mobile station [yes, S802], the mobile station measures a downlink channel [S903], sends a ranging request (AAI-RNG-REQ) message containing a measured MIMO feedback information [S904], and then waits for a ranging response (AAI-RNG-RSP) message from a base station. Thereafter, the mobile station performs the rest of a network entry (or reentry) procedure [S905]. If the mobile station is not the fixed mobile station [no, S902], the mobile station performs a previous normal network entry (or reentry) procedure [S904].

FIG. 10 is a flowchart of a feedback performing process when an M2M device performs a network entry (or reentry) procedure according to a further embodiment of the present invention.

Referring to FIG. 10, a mobile station initiates a network entry (or reentry) procedure [S1001]. Only if the mobile station is a fixed mobile station [yes, S1002], the mobile station sends a ranging request (AAI-RNG-REQ) message containing a last used MIMO feedback information [S1003] and then waits for a ranging response (AAI-RNG-RSP) message from a base station. Thereafter, the mobile station performs the rest of a network entry (or reentry) procedure [S1006]. If the mobile station is not the fixed mobile station, the mobile station measures a downlink channel [S1004], sends a ranging request (AAI-RNG-REQ) message containing a measured MIMO feedback information [S1005], and then waits for a ranging response (AAI-RNG-RSP) message from the base station. Subsequently, the mobile station performs the rest of the network entry (or reentry) procedure [S1006].

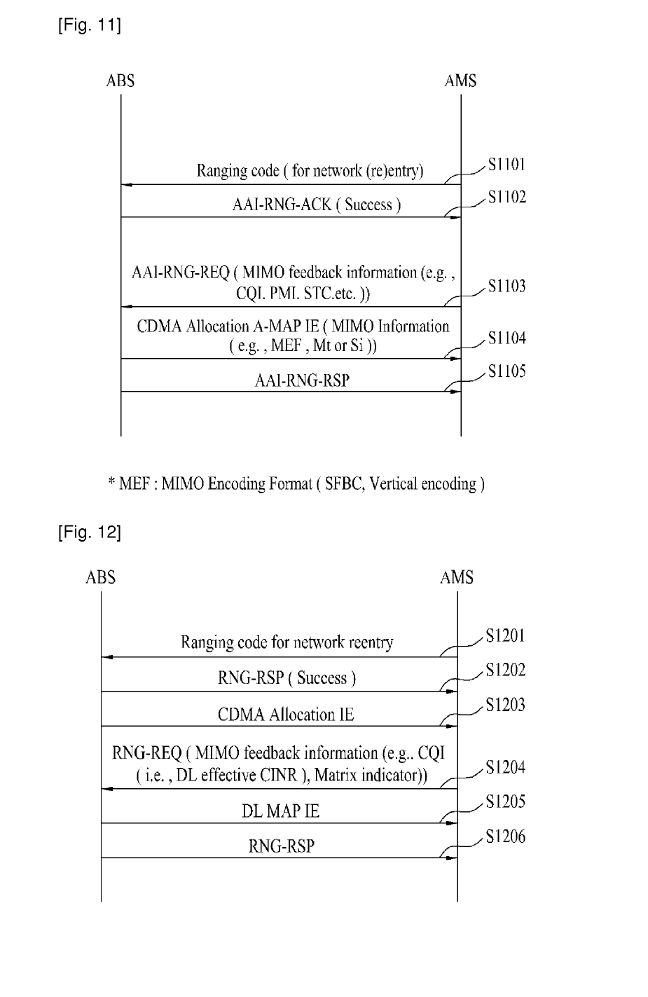

FIG. 11 is a flowchart of a process for performing a network entry procedure between a mobile station and a base station according to one embodiment of the present invention.

Referring to FIG. 11, a mobile station transmits a ranging code for a network entry (or reentry) to a base station [S1101]. The base station sends a ranging acknowledgment (success) message to the mobile station [S1102]. If the mobile station sends a ranging request (AAI-RNG-REQ) message containing MIMO information (e.g., CQI, PMI, STC, etc.) [S1103], the base station may be able to transmit downlink data by applying an MIMO mode appropriate for the mobile station in a manner that an MIMO encoding format (MEF) or the transmitting antenna number (Mt) is contained in a CDMA allocation A-MAP IE in sending a ranging response (AAI-RNG-RSP) message [S1104. S1105]. In this case, the MIMO encoding format (MEF) may include SFBC (space frequency block coding) or vertical encoding.

Table 1 shows one example of a ranging request (AAI-RNG-REQ) message sent by a mobile station in a manner of containing MIMO feedback information.

In Table 1, MFM (MIMO feedback mode) bitmap means a bitmap indicating an MIMO feedback mode for a mobile station to transmit a feedback.

A wideband CQI (channel quality indicator) indicates one CQI average value across a whole band and a subband CQI indicates one CQI average value across a subband. Wideband STC (space time coding) is a space time coding across a whole band. Wideband PMI (preferred matrix index) is a matrix index preferred across a whole band. In accordance with MFM bitmap, a feedback may be transmitted in a manner of containing wideband CQI, Wideband STC, Wideband PMI and the like.

TABLE 1

| | Size | | |
|---|---|---|---|
| Field | (bits) | Value | Condition |
| Ranging purpose in- | 4 | | |
| dication | | | |
| CMAC Indicator | 1 | | |
| ... | ... | | ... |
| } else if (Ranging | | | |
| Purpose Indication== | | | |
| 0b0010) { | | | |
| if (S-SFH Network Con- | | | |
| figurationbit == 0b1 or | | | |
| AMSID privacyis | | | |
| disabled){ | | | |
| AMS MAC address | 48 | | |
| } else{ | | | |
| Deregistration Identifier | 18 | | |
| (DID) | | | |
| } | | | |
| MFM bitmap | 2 | Maximum of 3 distinct | |
| | | concurrent MFM are | |
| | | allowed with MFM bitmap. | |
| | | LSB #0: MFM 0LSB #1: | |
| | | MFM 4 | |
| If (LSB#0 in | | | |
| MFM bitmap ==1){ | | | |
| Wideband CQI | | | |
| Wideband STC rate | 3 | .‘STC rate - 1.’ mapped to | |
| | | 3-bit unsigned integer(i.e., | |
| | | STC rate=1 as 0b000 ~ STC | |
| | | rate=8 as 0b111) | |
| } | | | |
| If (LSB#1 in | | | |
| MFM bitmap == 1){ | | | |
| Wideband CQI | 4 | | |
| Wideband STC | 3 | .‘STC rate - 1.’ mapped to | |
| | | 3-bit unsigned integer(i.e., | |
| | | STC rate=1 as 0b000 ~ STC | |
| | | rate=8 as 0b111) | |
| Wideband PMI | 6 | wideband preferred matrix | |
| | | index (PMI), size of which | |
| | | is number of PMI bits | |
| | | (.‘NB.’) used,mapped to NB | |
| | | LSB bits of this field, while | |
| | | the remaining MSB bit(s) | |
| | | set to zero(0) | |
| } | | | |
| Paging Controller ID | | | |
| ... | | | |
| } else if (Ranging | | | |
| Purpose Indication== | | | |
| 0b0011\|0b0110\|0b0111\| | | | |
| 0b1011) { | | | |
| ... | ... | | ... |

After a base station has received MIMO feedback information contained in a ranging request (AAI-RNG-REQ) message, when the base station sends a ranging response (AAI-RNG-RSP) message via CDMA Allocation A-MAP IE, the base station may be able to transmit the CDMA Allocation A-MAP IE in which MIMO mode information appropriate fro a mobile station is contained. In particular, when a ranging response (AAI-RNG-RSP) message is sent via the CDMA Allocation A-MAP IE, an MIMO mode appropriate for the mobile station is applied.

Table 2 shows one example of CDMA Allocation A-MAP IE modified for the present invention. It may be able to transmit downlink data by applying an MIMO mode appropriate for a mobile station in a manner that MIMO encoding format (MEF) or the transmitting antenna number (Mt) is contained using 8 bits of CDMA Allocation A-MAP IE, which are not previously allocated.

TABLE 2

| | Size | |
|---|---|---|
| Syntax | (bits) | Notes |
| CDMA_Allocation_A-MA | | |
| P IE { | | |
| A-MAP IE type | 4 | CDMA Allocation A-MAP IE |
| CDMA allocation in- | 1 | 0b0: Bandwidth allocation in response to a |
| dication | | received contention-based bandwidth |
| | | request.0b1: Bandwidth allocation in response |
| | | to a received contention-based ranging request |
| If (CDMA allocation in- | | |
| dication ==0b0){ | | |
| ... | ... | ... |
| } | | |
| Else if (CDMA allocation in- | | |
| dication ==0b1) { | | |
| Uplink/Downlink Indicator | 1 | Indicates whether the following fields are for |
| | | resource assignment in the uplink or in the |
| | | downlink.0b0: Uplink0b1: Downlink |
| Resource Index | 11 | |
| ISizeOffset | 5 | |
| HFA | 3 | |
| If (Uplink/Downlink | | |
| Indicator==0b0) { | | |
| ... | ... | ... |
| } Else { | | |
| ACID | 4 | |
| AI_SN | 1 | |
| SPID | 2 | |
| Reserved | 8 | |
| MEF | 1 | MIMO encoder format0b00: SFBC0b01: |
| | | Vertical encoding |
| if (MEF == 0b01){ | | |
| Mt | 3 | |
| Reserved | 4 | |
| } else { | | |
| Reserved | 7 | |
| } | | |
| } | | |

Table 3 shows one example of a ranging request (AAI-RNG-REQ) message.

In accordance with MIMO feedback mode, a mobile station may upload various kinds of MIMO feedback informations.

TABLE 3

| | Size | | |
|---|---|---|---|
| Field | (bits) | Value | Condition |
| Ranging purpose in- | 4 | | |
| dication | | | |
| CMAC Indicator | 1 | | |
| ... | ... | | ... |
| } else if (Ranging | | | |
| Purpose Indication== | | | |
| 0b0010) { | | | |
| if (S-SFH Network Con- | | | |
| figurationbit == 0b1 or | | | |
| AMSID privacyis | | | |
| disabled){ | | | |
| AMS MAC address | 48 | | |
| } else{ | | | |
| Deregistration Identifier | 18 | | |
| (DID) | | | |
| } | | | |
| Wideband CQI | 4 | | |
| Wideband STC | 3 | .‘STC rate - 1.’ mapped to | |
| | | 3-bit unsigned integer(i.e., | |
| | | STC rate=1 as 0b000 ~ STC | |
| | | rate=8 as 0b111) | |
| Wideband PMI | 6 | Wideband preferred matrix | |
| | | index (PMI), size of which | |
| | | is number of PMI bits | |
| | | (.‘NB.’) used,mapped to NB | |
| | | LSB bits of this field, while | |
| | | the remaining MSB bit(s) | |
| | | set to zero(0) | |
| Paging Controller ID | | | |
| ... | | | |
| } else if (Ranging | | | |
| Purpose Indication== | | | |
| 0b0011\|0b0110\|0b0111\| | | | |
| 0b1011) { | | | |
| ... | ... | | ... |

Table 4 shows another example of a ranging request (AAI-RNG-REQ) message.

In Table 4, MFM bitmap is used to selectively send information related to wideband and is sent by containing feedback information corresponding to a bit set to 1 only.

TABLE 4

| | Size | | |
|---|---|---|---|
| Field | (bits) | Value | Condition |
| Ranging purpose in- | 4 | | |
| dication | | | |
| CMAC Indicator | 1 | | |
| ... | ... | | ... |
| } else if (Ranging | | | |
| Purpose Indication== | | | |
| 0b0010) { | | | |
| if (S-SFH Network Con- | | | |
| figurationbit == 0b1 or | | | |
| AMSID privacyis | | | |
| disabled){ | | | |
| AMS MAC address | 48 | | |
| } else{ | | | |
| Deregistration Identifier | 18 | | |
| (DID) | | | |
| } | | | |
| MFM bitmap | 3 | Maximum of 3 distinct | |
| | | concurrent MFM are | |
| | | allowed with MFM bitmap. | |
| | | If a currently allocated | |
| | | MFM is indicated in the | |
| | | MFM bitmap, it indicates a | |
| | | deallocation and real- | |
| | | location of this MFM. ACK | |
| | | Allocation Flag shall be set | |
| | | to 0b1 in this case.LSB #0: | |
| | | MFM 0LSB #1: MFM 4 | |
| | | LSB #2: MFM 7 | |
| If (LSB#0 in | | | |
| MFM bitmap == 1){ | | | |
| MaxMt | 1~2 | | |
| Measurement Method In- | 1 | 0b0: Use the midamble for | |
| dication | | CQI measurements0b1: Use | |
| | | pilots in OL region with | |
| | | MaxMt streamsforCQImea- | |
| | | surements | |
| Wideband CQI | | | |
| Wideband STC rate | 3 | .‘STC rate - 1.’ mapped to | |
| | | 3-bit unsigned integer(i.e., | |
| | | STC rate=1 as 0b000 ~ STC | |
| | | rate=8 as 0b111) | |
| } | | | |
| If (LSB#1 in | | | |
| MFM bitmap == 1){ | | | |
| MaxMt | 1~2 | | |
| Wideband CQI | 4 | | |
| Wideband STC | 3 | .‘STC rate - 1.’ mapped to | |
| | | 3-bit unsigned integer(i.e., | |
| | | STC rate=1 as 0b000 ~ STC | |
| | | rate=8 as 0b111) | |
| Wideband PMI | 6 | Wideband preferred matrix | |
| | | index (PMI), size of which | |
| | | is number of PMI bits ( | |
| | | ‘NB.’) used,mapped to NB | |
| | | LSB bits of this field, while | |
| | | the remaining MSB bit(s) | |
| | | set to zero(0) | |
| } | | | |
| If (LSB#2 in | | | |
| MFM bitmap == 1){ | | | |
| MaxMt | 1~2 | | |
| Wideband CQI | 4 | | |
| Wideband PMI | 6 | Wideband preferred matrix | |
| | | index (PMI), size of which | |
| | | is number of PMI bits | |
| | | ‘NB.’) used,mapped to NB | |
| | | LSB bits of this field, while | |
| | | the remaining MSB bit(s) | |
| | | set to zero(0) | |
| } | | | |
| Paging Controller ID | | | |
| ... | | | |
| } else if (Ranging | | | |
| Purpose Indication== | | | |
| 0b0011\|0b0110\|0b0111\| | | | |
| 0b1011) { | | | |
| ... | ... | | ... |

Table 5 shows another example of a ranging request (AAI-RNG-REQ) message. A mobile station sends Wideband CQI information only. Using this information, MIMO encoder format usable by a base station may become SFBC (space frequency block coding).

TABLE 5

| | Size | | |
|---|---|---|---|
| Field | (bits) | Value | Condition |
| Ranging purpose in- | 4 | | |
| dication | | | |
| CMAC Indicator | 1 | | |
| ... | ... | | ... |
| } else if (Ranging | | | |
| Purpose Indication== | | | |
| 0b0010) { | | | |
| if (S-SFH Network Con- | | | |
| figurationbit == 0b1 or | | | |
| AMSID privacyis | | | |
| disabled){ | | | |
| AMS MAC address | 48 | | |
| } else{ | | | |
| Deregistration Identifier | 18 | | |
| (DID) | | | |
| } | | | |
| Wideband CQI | 4 | | |
| Paging Controller ID | | | |
| ... | | | |
| } else if (Ranging | | | |
| Purpose Indication== | | | |
| 0b0011\|0b0110\|0b0111\| | | | |
| 0b1011) { | | | |
| ... | ... | | ... |

In case of mobile stations having no mobility, channel variation does not occur frequently. Instead of transmitting channel quality feedback or MIMO feedback using a resource periodically allocated by feedback allocation A-MAP IE or feedback polling A-MAP IE by a base station, only if a mobile station needs to modify a corresponding information, the bas station may be able to set the corresponding feedback information to be transmitted by an even of the mobile station.

To this end, when the mobile station performs a network entry (or reentry), the base station sets a feedback mode of the mobile station in performing capability negotiation (via SBC-RSP or REG-RSP (ranging response) message) and may then inform the mobile station of the feedback mode. In case that the feedback mode of the corresponding mobile station is an event triggered method, when an event mode for a predetermined condition occurs, the mobile station may send an MIMO feedback header (MFH) or AAI-SBS-MIMO-FBK message for a channel quality feedback transmission or an MIMO feedback transmission to the base station.

Table 6 shows one example of AAI-SBC-RSP message field.

Referring to Table 6, an MFM indicator may be transmitted in a manner of being contained in an AAI-SBC-RSP message. As a value indicating an MIMO feedback mode, if an MFM indicator is set to 0, MIMO feedback is performed by poling of a base station. If the MFM indicator is set to 1, a message is performed by an event triggered method.

TABLE 6

| | Size | | |
|---|---|---|---|
| Field | (bits) | Value | Condition |
| . . . | . . . | . . . | . . . |
| MFM indicator | 1 | MIMO feedback mode0: | |
| | | MIMO feedback by polling | |
| | | of the BS1: Event triggered | |
| | | method | |
| . . . | . . . | . . . | . . . |

Table 7 shows one example of a ranging response (AAI-RNG-RSP) message field.

Referring to Table 7, an MFM indicator may be transmitted in a manner of being contained in a ranging resnonse (AAI-RNG-RSP) message.

TABLE 7

| | Size | | |
|---|---|---|---|
| Field | (bits) | Value | Condition |
| . . . | . . . | . . . | . . . |
| MFM indicator | 1 | MIMO feedback mode0: | |
| | | MIMO feedback by polling of | |
| | | the BS1: Event triggered | |
| | | method | |
| . . . | . . . | . . . | . . . |

Each of the above-proposed embodiments corresponds to a method of reducing unnecessary feedback overhead in IEEE 802.16m system in a manner of transmitting MIMO feedback information that is contained in a ranging response (AAI-RNG-RSP) message, CDMA allocation A-MAP IE or the like.

Table 8 shows one example of a resource allocation MAP IE in a previous system (e.g., 802.16e, 802.16m, etc.). In order to allocate a downlink or uplink resource to a mobile station, a base station uses MAP message (e.g., DL-MAP, UL-MAP, Sub-DL-UL-MAP IE, Compressed MAP, etc. in 802.16e) and MAP IE (e.g., UL basic assignment A-MAP IE, UL basic assignment A-MAP IE, etc. in 802.16m).

Table 8 shows one example of MAP IE used to carry MIMO information in allocating a resource to a mobile station having MIMO mode in 802.16e. Table 8 corresponds to a dedicated MIMO DL control IE format of a previous IEEE 16-2009 system.

TABLE 8

| | Size | |
|---|---|---|
| Synrax | (bit) | Notes |
| Dedicated_MIMO_DL_Control_IE{) { | — | — |
| Length | 5 | Length of control information in Nibbles, |
| | | including this field |
| Control header | 3 | Bit 0: MIMO Control Info |
| | | Bit 1: CQI Control Info |
| | | Bit 2: Closed MIMO Control Info |
| N_layer | 2 | Number of coding modulation layers |
| | | 0b00 = 1 laver |
| | | 0b0I = 2 layers |
| | | 0bI0 = 3 lavers |
| | | 0bI1 = 4 layers |
| if( MIMO Control Info ═ 1){ | — | — |
| Matrix | 2 | Indicates transmission matrix (See 8.4.8) |
| | | 0b00 = Matrix A |
| | | 0b0I = Matrix B |
| | | 0bI0 = Matrix C |
| | | 0bI1 = Codebook |
| if (Dedicated Pilots = 1) { | — | Dedicated Pilots field in SIC_Zone_IE{) |
| Num_Streams | 2 | Indicates the number of beamformed streams |
| | | which is equal to the number of pilot patterns |
| | | 0b00 = 1 stream |
| | | 0b0I = 2 streams |
| | | 0bI0 = 3 streams |
| | | 0bI1 = 4 streams |
| } | — | — |
| } | — | — |
| If( CQICH Control Info = 1) } | — | — |
| Period | 3 | Period (in frame) = 2 period |
| Frame offset | 3 | — |
| Durarion | 4 | A CQI feedback is transmitted on the CQI |
| | | channels indexed by the Allocation index for |
| | | 10 × 2^{d} frames |
| For (j = 0: N_layer − 1: j—) { | — | — |
| Allocation index¹ | 6 | Index to CQICH assigned to this layer |
| } | — | — |

In the following description, an embodiment of the present invention is explained with reference to a case of applying M2M communication to IEEE 802.16e system. In the IEEE 802.16e system, since MIMO information is delivered via one MAP message, joint coding is used. On the contrary, in IEEE 802.16m system, a separate coding scheme of coding each MAP message separately is used.

In the IEEE 802.16e system proposed in the following, an operation between a mobile station and a base station according to the present invention is shown in FIG. 12.

Referring to FIG. 12, a mobile station transmits a ranging code to perform a network reentry to a base station [S1201]. If the mobile station transmits MIMO information (e.g., CQI, PMI, STC, etc.) in a manner that the MIMO information is contained in a ranging request (AAI-RNG-REQ), the blasstation may be able to transmit downlink data by applying an MIMO mode appropriate for the mobile station in a manner that an MIMO encoding format (MEF) or the transmitting antenna number (Mt) is contained in a CDMA allocation A-MAP IE in sending a ranging response (AAI-RNG-RSP) message [S1203 to S1206].

When a fixed mobile station (or M2M device) makes a transition to a connected mode from an idle mode, the present invention proposes a method for a base station to transmit downlink traffic using an appropriate MIMO mode by quickly apply a channel situation.

According to a related art, after a mobile station has performed a network entry, a base station allocates a primary fast feedback control channel to the mobile station using feedback allocation A-MAP IE or feedback polling A-MAP IE and the mobile station then transmits MIMO related fast feedback information to the base station via the allocated channel. Using the MIMO information received from the mobile station, when the base station allocates a resource, the base station sets an MIMO mode of the mobile station. Yet, this method has such a problem that the base station is unable to set the MIMO mode of the mobile station quickly until receiving feedback information from the mobile station by allocating a feedback channel to the mobile station.

According to the present invention, in order to apply an MIMO mode more quickly in a network reentry, when a mobile station sends a ranging request (AAI-RNG-REQ) message, the mobile station transmits MIMO mode and channel information in a manner that the MIMO mode and the channel information are contained in the ranging request (AAI-RNG-REQ) message.

When the mobile station performs a network reentry, if the corresponding mobile station has an attribute of non-mobility, the mobile station may be able to send a ranging request (AAI-RNG-REQ) message in a manner that MIMO information (e.g., CQI (DL effective CINR (Carrier to Interface Ratio)), matrix indicator, etc.) is contained in the ranging request (AAI-RNG-REQ) message. In this case, the CQI indicates a value of the DL effective CINR (Carrier to Interface Ratio) and the matrix indicator indicates matrix information (indicating a matrix A or a matrix B) supported by the mobile station [S1203]. The base station may be able to use the corresponding MIMO information for all downlink (DL) bursts since sending a ranging response (AAI-RNG-RSP) message in response to the ranging request (AAI-RNG-REQ) message [S12-5, S1206].

Table 9 shows one example of MIMO feedback information TLV contained in a ranging request (AAI-RNG-REQ) message.

Referring to Table 9, if a base station receives MIMO feedback information on a mobile station via a ranging request (AAI-RNG-REQ) message in the course of a ranging procedure of the mobile station, the base station may be able to determine a burst profile for DL bursts (e.g., RNG-RSP, etc.), i.e., an MCS and a matrix indicator of DL MIMO mode, using the received information.

TABLE 9

| | | | | PHY |
|---|---|---|---|---|
| NAME | Type | Length | Value | Scope |
| MIMO | 41 | 1 | Bit #0: Matrix indicator. This field | All |
| feedback | | | suggests the preferred STC/MIMO | |
| information | | | matrix for the MS:0b0: Matrix | |
| | | | A0b1: Matrix B | |
| | | | Bit #1 ~ Bit#4: DL effective CINR | |
| | | | as defined in Table | |
| | | | 520Bit #5-Bit#7: reserved | |

Table 10 shows another example of MIMO feedback information TLV encoding contained in a ranging request (AAI-RNG-REQ) message.

Referring to Table 10, MIMO feedback information is the information that is contained in a ranging request (AAI-RNG-REQ) message sent by a mobile station.

TABLE 10

| NAME | Type | Length | Value |
|---|---|---|---|
| MIMO feedback | X | 4 | MIMO feedback information |
| information | | | contained when MS sends RNG-REQ |
| | | | and its details are shown in Table 11 |

Table 11 shows one example of MIMO channel feedback information contained in a ranging request (AAI-RNG-REQ) message.

TABLE 11

| | Size | |
|---|---|---|
| NAME | (bits) | Value |
| PRE- | 4 | Index of the preferred DIUC suggested by the MS. |
| FER- | | |
| RED- | | |
| DIUC | | |
| PBWI | 4 | Preferred bandwidth index. This field provides the size |
| | | of the preferredbandwidth, which can be used for DIUC |
| | | transmission.PBWI indicates the ratio of the preferred |
| | | bandwidth over used channelbandwidth:0b0000: 1 |
| | | 0b0001: 3/40b0010: 2/30b0011: 1/20b0100: 1/30b0101: |
| | | 1/40b0110: 1/50b0111: 1/60b1000: 1/80b1001: 1/10 |
| | | 0b1010: 1/120b1011: 1/160b1100: 1/240b1101: 1/32 |
| | | 0b1110: 1/480b1111: 1/64whereRatio = BWpreferred/ |
| | | BWused,BWpreferred: Preferred bandwidth for DIUC |
| | | transmission,BWused: Actual used channel bandwidth |
| | | (excluding guard bands). |
| SLPB | 7 | Starting location of preferred bandwidth: 0127.This |
| | | field points to the starting preferred bandwidth location. |
| | | This field,combined with the PBWI field, tells the BS |
| | | the exact size and location of thepreferred bandwidth in |
| | | the channel.The effective bandwidth (used bandwidth) |
| | | is divided into 128 intervalsnumbered 0 to 127 counting |
| | | from the lower to the higher band. SLPB indicatesthe |
| | | starting location of preferred bandwidth for the DIUC |
| | | burst profile. |
| BPRI | 2 | Burst profile ranking indicator. This field can be used to |
| | | rank up to four preferredburst profiles within the DL |
| | | channel.BPRI (without Basic CID) indicates the |
| | | ranking for DL channel condition ofthe preferred |
| | | bandwidth as reported in the current header where 0 is |
| | | the mostpreferred bandwidth:0b00: 1st preferred burst |
| | | profile0b10: 2nd preferred burst profile0b01: 3rd |
| | | preferred burst profile0b11: 4th preferred burst profile |
| | | BPRI (including Basic CID):0b0: 1st preferred burst |
| | | profile0b 1: 2nd preferred burst profile |
| CTI | 3 | Coherent time index. This field provides coherent time |
| | | information.CTI indicates the estimated duration of the |
| | | valid MIMO channel conditions:0b000: Infinite0b001: |
| | | 1 frame0b010: 2 frames0b011: 3 frames0b100: 4 |
| | | frames0b101: 8 frames0b110: 14 frames0b111: 24 |
| | | frames |
| AI | 4 | Antenna index. This field is for antenna indication. It |
| | | can support up to fourantennas.This feedback header |
| | | can report a composite channel condition: each bit |
| | | represents for each antenna: “1“ is applicable, “0” is not |
| | | applicable.AI:Bit 0 (MSB) Antenna 0Bit 1 Antenna 1 |
| | | Bit 2 Antenna 2Bit 3 (LSB) Antenna 3 |
| MI | 2 | Matrix indicator. This field suggests the preferred STC/ |
| | | MIMO matrix forthe MS:0b00: No STC0b01: Matrix A |
| | | 0b10: Matrix B0b11: Matrix C |
| CT | 1 | CQI type. This field indicates the type of CQI feedback |
| | | in the CQI field:0: DL average CQI feedback 1: CQI |
| | | feedback for the preferred bandwidth indicated in the |
| | | currentheader |
| CQI | 5 | CQI feedback. |

In IEEE 802.16e system proposed in the following, when a base station allocates resources to fixed mobile stations, the base station transmits a MAP in which an indication is contained. In particular, if MCS information (DIUC/UIUC) and MIMO information (matrix) used by the mobile station are identical to recent MCS information and recent MCS information, which are sent recently, the indication indicates to use the recent informations. Since channel variation of each fixed device barely occurs, MCS (DIUC/UIUC) or MIMO information (matrix information) used by a mobile station may not change for a considerably long time. If a base station inserts matrix information or MCS information each time allocates a resource, it may become an unnecessary MAP overhead. Therefore, the present invention intends to provide a method of efficiently allocate a resource to a mobile station or M2M device having no mobility. Unlike IEEE 802.16m system, since CDMA allocation IE is used in uplink (UL) only, MIMO feedback information is not transmitted. There is a difference in that a mobile station sends a ranging request (AAI-RNG-REQ) message in a manner that MIMO feedback information is contained in the ranging request (AAI-RNG-REQ) message only.

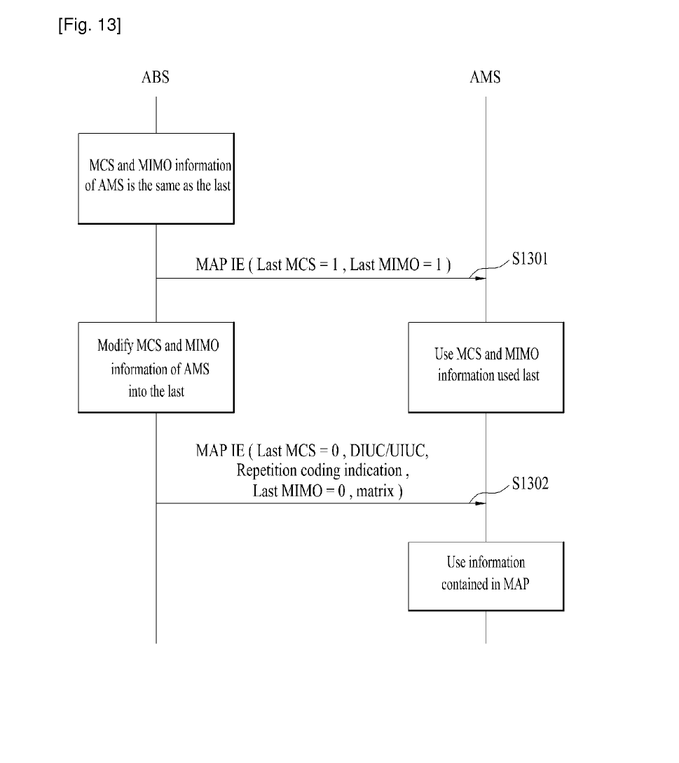

FIG. 13 is a flowchart of a process for performing a feedback when a fixed M2M device performs a network entry (or reentry) according to a further embodiment of the present invention.

Referring to FIG. 13, when a base station allocates resources to fixed mobile stations, if MCS information (DIUC/UIUC: downlink interval usage code/uplink interval usage code) and MIMO information (matrix) used by the mobile station are identical to recent MCS information and recent MCS information, which are sent recently, the base station transmits a MAP in which an indication indicating to use the recent informations is contained [S1301]. In this case, explicit MCS information and explicit MIMO information are not contained. Yet, if MCS information (DIUC/UIUC: downlink interval usage code/uplink interval usage code) and MIMO information (matrix) used by the mobile station are different from recent MCS information and recent MCS information, which are sent recently, the base station transmits a MAP in which explicit MCS information and explicit MIMO information are contained [S1302]. In this case, it may be able to use the matrix information contained in the MAP message.

Tables 12 to 17 in the following indicate MAPs, in each of which a last MCS indication and a last MIMO indication in the previously defined UL/DL HARQ MAP IE are modified for resource allocation of fixed M2M devices.

Table 12 shows DL HARQ chase Subburst IE format.

Referring to Table 12, the same DIUC as the previous burst indicates a latest DIUC information except a DIUC information having a subburst DIUC indicator set to 1 and a last DIUC indicator set to 1 in a previous allocation. If a currently used DIUC information is equal to a DIUC information most recently used by a corresponding mobile station, the last DIUC indicator is set to 0. If the last DIUC indicator is set to 1, DIUC information is different and the DIUC information is allocated for this subburst.

TABLE 12

| | Size | |
|---|---|---|
| Syntax | (bits) | Notes |
| DL_HARQ_ | | Subburst |
| Chase_ | | |
| Subburst_ | | |
| IE () { | | |
| N subburst | 4 | |
| . . . | . . . | . . . |
| subburst DIUC | 1 | If subburst DIUC Indicator is 1, it indicates |
| Indicator | | thatDIUC is explicitly assigned for this |
| | | subburst.Otherwise, this subburst shall use the |
| | | same DIUCas the previous subburst. In this case, |
| | | the same DIUCas the previous burst indicates a |
| | | latest DIUC information except a DIUC in- |
| | | formation having a subburst DIUC indicator set |
| | | to 1 and a last DIUC indicator set to 1 in a |
| | | previous allocation.If j is 0 then this indicator |
| | | shall be 1 |
| Group | 1 | |
| Indicator | | |
| If( subburst | | |
| DIUC Indi- | | |
| cator == 1){ | | |
| Last DIUC | 1 | If a currently used DIUC information is equal to |
| indicator | | a DIUC information most recently used by a cor- |
| | | responding mobile station, the last DIUC |
| | | indicator is set to 0. If the last DIUC indicator is |
| | | set to 1, DIUC information is different and the |
| | | DIUC information is allocated for this subburst. |
| If (Last DIUC | | |
| indicator == 1) | | |
| {DIUC | 4 | |
| Repetition | 2 | 0b00: No repetition coding0b01: Repetition |
| Coding | | coding of 2 used0b10: Repetition coding of 4 |
| Indication | | used0b11: Repetition coding of 6 used |
| Reserved | 2 | Shall be set to zero |
| } | | |
| } | | |
| . . . | . . . | . . . |
| Padding | | |

Table 13 shows DL HARQ IR CC Subburst IE format.

Referring to Table 13, like Table 12, the same DIUC as the previous burst indicates a latest DIUC information except a DIUC information having a subburst DIUC indicator set to 1 and a last DIUC indicator set to 1 in a previous allocation. If a currently used DIUC information is equal to a DIUC information most recently used by a corresponding mobile station, the last DIUC indicator is set to 0. If the last DIUC indicator is set to 1, DIUC information is different and the DIUC information is allocated for this subburst.

TABLE 13

| | Size | |
|---|---|---|
| Syntax | (bits) | Notes |
| DL_HARQ_IR_CC_ | | |
| Subburst_IE () { | | |
| N subburst | 4 | |
| . . . | . . . | . . . |
| subburst DIUC | 1 | If subburst DIUC Indicator is 1, it |
| Indicator | | indicates thatDIUC is explicitly assigned |
| | | for this subburst.Otherwise, this subburst |
| | | shall use the same DIUCas the previous |
| | | subburst. In this case, the same DIUC as |
| | | the previous burst indicates a latest |
| | | DIUC information except a DIUC in- |
| | | formation having a subburst DIUC |
| | | indicator set to 1 and a last DIUC |
| | | indicator set to 1 in a previous al- |
| | | location.If j is 0 then this indicator shall |
| | | be 1 |
| Group Indicator | 1 | |
| If( subburst DIUC | | |
| Indicator ==1){ | | |
| Last DIUC indicator | 1 | If a currently used DIUC information is |
| | | equal to a DIUC information most |
| | | recently used by a corresponding mobile |
| | | station, the last DIUC indicator is set to |
| | | 0. If the last DIUC indicator is set to 1, |
| | | DIUC information is different and the |
| | | DIUC information is allocated for this |
| | | subburst. |
| If (Last DIUC | | |
| indicator ==1) { | | |
| DIUC | 4 | |
| Repetition Coding | 2 | 0b00: No repetition coding0b01: |
| Indication | | Repetition coding of 2 used0b10: |
| | | Repetition coding of 4 used0b11: |
| | | Repetition coding of 6 used |
| Reserved | 2 | Shall be set to zero |
| } | | |
| } | | |
| . . . | . . . | . . . |
| Padding | | |

Table 14 shows one example of MIMO DL Chase HARQ subburst IE format.

Referring to Table 14, if a currently used DIUC information is equal to a DIUC information most recently used by a corresponding mobile station, the last DIUC indicator is set to 0. If the last DIUC indicator is set to 1, DIUC information is different and the DIUC information is allocated for this subburst.

TABLE 14

| | Size | |
|---|---|---|
| Syntax | (bits) | Notes |
| MIMO_DL_ | | |
| Chase_HARQ_ | | |
| subburst_IE() () { | | |
| N subburst | 4 | |
| . . . | . . . | . . . |
| if (MU | | |
| indicator == 1) { | | |
| RCID IE() | | |
| } | | |
| Last DIUC | 1 | If a currently used DIUC information is equal |
| indicator | | to a DIUC information most recently used |
| | | by a corresponding mobile station, this field is |
| | | set to 0. If this field is set to 1, DIUC |
| | | information is different and the DIUC |
| | | information is allocated for this subburst. |
| If (Last DIUC | | |
| indicator | | |
| == 1) { | | |
| DIUC | 4 | |
| Repetition | 2 | 0b00: No repetition coding0b01: Repetition |
| Coding | | coding of 2 used0b10: Repetition coding of 4 |
| Indication | | used0b11: Repetition coding of 6 used |
| } | | |
| } | | |
| . . . | . . . | . . . |
| Padding | | |

Table 15 shows one example of MIMO DL IR HARQ for CC Subburst IE format.

Referring to Table 15, if a currently used DIUC information is equal to a DIUC information most recently used by a corresponding mobile station, the last DIUC indicator is set to 0. If the last DIUC indicator is set to 1, DIUC information is different and the DIUC information is allocated for this subburst.

TABLE 15

| | Size | |
|---|---|---|
| Syntax | (bits) | Notes |
| MIMO_DL_IR_HARQ_for_CC_ | | |
| subburst_IE () { | | |
| N subburst | 4 | |
| . . . | . . . | . . . |
| if (MU indicator == 1) { | | |
| RCID IE() | | |
| } | | |
| Last DIUC indicator | 1 | If a currently used DIUC information is |
| | | equal to a DIUC information most recently |
| | | used by a corresponding mobile station, |
| | | this field is set to 0. If this field is set to 1, |
| | | DIUC information is different and the |
| | | DIUC information is allocated for this |
| | | subburst. |
| If (Last DIUC indicator == 1) { | | |
| DIUC | 4 | |
| Repetition Coding Indication | 2 | 0b00: No repetition coding0b01: |
| | | Repetition coding of 2 used0b10: |
| | | Repetition coding of 4 used0b11: |
| | | Repetition coding of 6 used |
| } | | |
| } | | |
| . . . | . . . | . . . |
| padding | | |

Table 16 shows one example of MIMO DL STC HARQ Subburst IE format.

Referring to Table 16, if a currently used DIUC information is equal to a DIUC information most recently used by a corresponding mobile station, the last DIUC indicator is set to 0. If the last DIUC indicator is set to 1, DIUC information is different and the DIUC information is allocated for this subburst.

TABLE 16

| | Size | |
|---|---|---|
| Syntax | (bits) | Notes |
| MIMO_DL_STC_HARQ_subburst_I | | |
| E () { | | |
| N subburst | 4 | |
| . . . | . . . | . . . |
| if (Dedicated MIMO DL Control | | |
| Indicator == 1)) { | | |
| Dedicated MIMO DL Control IE () | | |
| } | | |
| Last DIUC indicator | 1 | If a currently used DIUC in- |
| | | formation is equal to a DIUC in- |
| | | formation most recently used by a |
| | | corresponding mobile station, this |
| | | field is set to 0. If this field is set to |
| | | 1, DIUC information is different and |
| | | the DIUC information is allocated |
| | | for this subburst. |
| If (Last DIUC indicator == 1) { | | |
| DIUC | 4 | |
| Repetition Coding Indication | 2 | 0b00: No repetition coding0b01: |
| | | Repetition coding of 2 used0b10: |
| | | Repetition coding of 4 used0b11: |
| | | Repetition coding of 6 used |
| } | | |
| } | | |
| . . . | . . . | . . . |
| padding | | |

Table 17 shows one example of Dedicated MIMO DL Control IE format.

Referring to Table 17, if a currently used MIMO control information (MIMO Control Info & Closed MIMO Control Info) is equal to an MIMO information most recently used by a corresponding mobile station and a CQI control information (CQI Control Info) is not allocated, a last MIMO information indicator (last MIMO Info indicator) is set to 0. If the last MIMO information indicator (last MIMO Info indicator) is set to 1, it is transmitted by containing the CQI control information (CQI Control Info), the MIMO control information (MIMO Control Info) and the Closed MIMO control information.

TABLE 17

| | Size | |
|---|---|---|
| Syntax | (bits) | Notes |
| Dedicated_MIMO_DL_ | | |
| Control_IE () { | | |
| Length | 5 | |
| Last MIMO Info indicator | 1 | If a currently used MIMO control information |
| | | (MIMO Control Info & Closed MIMO Control |
| | | Info) is equal to an MIMO information most |
| | | recently used by a corresponding mobile station |
| | | and a CQI control information (CQI Control |
| | | Info) is not allocated, this field is set to 0. If set to |
| | | 1, this field is transmitted by containing CQI |
| | | Control Info, MIMO Control Info and Closed |
| | | MIMO control information. |
| If (Last MIMO Info | | |
| indicator == 1) { | | |
| Control header | 3 | Bit 0: MIMO Control InfoBit 1: CQI Control |
| | | InfoBit 2: Closed MIMO Control Info |
| N_layer | 2 | Number of coding/modulation layers0b00 = 1 |
| | | layer0b01 = 2 layers0b10 = 3 layers0b11 = 4 |
| | | layers |
| if( MIMO Control Info == | | |
| 1){ | | |
| Matrix | 2 | |
| if (Dedicated Pilots == 1) | | |
| { | | |
| Num_Streams | | |
| } | | |
| . . . | . . . | . . . |
| Codebook Precoding | | Indicates the index of precoding matrix W inthe |
| Index | | codebook (see 8.4.8.3.6) |
| } | | |
| } | | |
| } | | |
| padding | | Padding to Nibble; shall be set to 0 |
| } | | |

For the fixed M2M devices including the above information, it may be able to define a new MAP. Fields of the newly defined MAP will be the same as the above-modified MAP IEs. Table 18 and Table 19 show new MAPs.

Table 18 shows one example of M2M HARQ DL MAP IE format.

TABLE 18

| | Size | |
|---|---|---|
| Syntax | (bits) | Notes |
| M2M HARQ DL MAP IE() { | | |
| Extended-2 DIUC | 4 | |
| Length | 8 | . . . |
| RCID_Type | | |
| ACK region index | | |
| Reserved | | |
| While (data remains) { | | |
| Boosting | | |
| Region_ID use indicator | | |
| . . . | . . . | . . . |
| Mode | 4 | Indicates the mode of this HARQ |
| | | region:0b0000: M2M DL Chase |
| | | HARQ0b0001: M2M DL Incremental |
| | | redundancy HARQ for CTC0b0010: |
| | | M2M DL Incremental redundancy |
| | | HARQ for ConvolutionalCode |
| | | 0b0011: M2M DL MIMO Chase |
| | | HARQ0b0100: M2M DL MIMO IR |
| | | HARQ0b0101: M2M DL MIMO IR |
| | | HARQ for Convolutional Code |
| | | 0b0110: M2M DL MIMO STC |
| | | HARQ0b01110b1111: Reserved |
| Subburst IE Length | 8 | |
| If (Mode == 0b0000) { | | |
| M2M | 1 | |
| DL HARQ Chase subburst IE( ) | | |
| } else if (Mode == 0b0001) { | 1 | |
| . . . | . . . | . . . |
| } | | |
| } | | |
| padding | | |

Table 19 shows one example of M2M DL HARQ Chase Subburst IE format.

Referring to Table 19, the same DIUS as a previous burst indicates a latest DIUC information except a DIUC information having a subburst DIUC indicator set to 1 and a last DIUC indicator set to 1 in a previous allocation. If a currently used DIUC information is equal to a DIUC information most recently used by a corresponding mobile station, the last DIUC indicator is set to 0. If the last DIUC indicator is set to 1, DIUC information is different and the DIUC information is allocated for this subburst.

TABLE 19

| | Size | |
|---|---|---|
| Syntax | (bits) | Notes |
| M2M DL HARQ Chase Su | | |
| bburst IE ( ) { | | |
| N subburst | 4 | |
| . . . | . . . | . . . |
| subburst DIUC Indicator | 1 | If subburst DIUC Indicator is 1, it indicates |
| | | thatDIUC is explicitly assigned for this |
| | | subburst.Otherwise, this subburst shall use the |
| | | same DIUCas the previous subburst. In this |
| | | case, the same DIUS as a previous burst |
| | | indicates a latest DIUC information except a |
| | | DIUC information having a subburst DIUC |
| | | indicator set to 1 and a last DIUC indicator set |
| | | to 1 in a previous allocation.If j is 0 then this |
| | | indicator shall be 1 |
| Group Indicator | 1 | |
| If( subburst DIUC Indicator | | |
| == 1) { | | |
| Last DIUC indicator | 1 | If a currently used DIUC information is equal |
| | | to a DIUC information most recently used by |
| | | a corresponding mobile station, this field is set |
| | | to 0. If this field is set to 1, DIUC information |
| | | is different and the DIUC information is |
| | | allocated for this subburst. |
| If (Last DIUC indicator == 1) | | |
| } | | |
| DIUC | 4 | |
| Repetition Coding | 2 | 0b00: No repetition coding0b01: Repetition |
| Indication | | coding of 2 used0b10: Repetition coding of 4 |
| | | used0b11: Repetition coding of 6 used |
| Reserved | 2 | Shall be set to zero |
| } | | |
| } | | |
| . . . | . . . | . . . |
| padding | | |

Sine the rest of the new HARQ subburst IEs will have the formats similar to those of the previous subburst IEs almost like DL_HARQ_Chase_Subburst_IE, details of the formats will be omitted. As the omitted part may reuse the informations contained in the previous MAP IE, it will be omitted in the description of the present invention.

Moreover, MCS (UIUC) information and MIMO information may be applicable to UL resource allocation in the same manner of the method in DL.

The present invention mentioned in the above description may be applicable to the M2M device 100 and the base station 150 shown in FIG. 1. Referring to FIG. 1, the processor 120 of the M2M device 100 configures a ranging request message to contain the MIMO feedback information according to one embodiment of the present invention and may be able to control the transmitter 111 to send the ranging request message to the base station 150. The processor 120 may control the receiver 112 to receive a ranging response message from the base station 150 in response to the ranging request message and may be then able to perform a network entry procedure on the base station. The processor 170 of the base station 150 may control the receiver 162 to receive the ranging request message containing MIMO feedback information from the M2M device 100. And, the processor 170 may control the transmitter 161 to send a ranging response message to the M2M device 100 using the ranging request message.

The above-described embodiments correspond to combinations of elements and features of the present invention in prescribed forms. And, it is able to consider that the respective elements or features are selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1.-10. (canceled)

11. A method of transmitting feedback information by a device in a wireless communication system, the method comprising:
transmitting a ranging request message by the device which is a fixed station to a base station, the ranging request message comprising the feedback information which is to be used for a multiple input multiple output (MIMO) scheme; and
receiving a ranging response message from the base station in response to the ranging request message.

12. The method of claim 11, wherein the device is a machine to machine (M2M) device which does not necessarily require human interactions to perform communications with another device.

13. The method of claim 11, further comprising transmitting a ranging code by the device to the base station to initiate a network entry or a network reentry before transmitting the ranging request.

14. The method of claim 11, wherein the feedback information comprises at least one of a channel quality indicator (CQI), a preferred matrix index (PMI), and a space time coding (STC).

15. The method of claim 11, wherein the feedback information comprises a MIMO feedback mode (MFM) bitmap which indicates a MIMO feedback mode to be used by the device.

16. The method of claim 15, wherein if a first least significant bit (LSB) is equal to “1” the feedback information further comprises a wideband channel quality indicator (CQI) which indicates an average value of CQIs across a whole band and a wideband space time coding (STC) which indicates a space time coding rate across the whole band.

17. The method of claim 15, wherein if a second least significant bit (LSB) is equal to “1” the feedback information further comprises a wideband channel quality indicator (CQI) which indicates an average value of CQIs across a whole band, a wideband space time coding (STC) which indicates a space timed coding rate across the whole band, and a wideband preferred matrix index (PMI) which indicates a preferred matrix index across the whole band.

18. A device for transmitting feedback information in a wireless communication system, the device comprising:
a transmitter configured to transmit a ranging request message to a base station, the ranging request message comprising the feedback information which is to be used for a multiple input multiple output (MIMO) scheme, wherein the device is a fixed station; and
a receiver configured to receive a ranging response message from the base station in response to the ranging request message.

19. The device of claim 18, wherein the device is a machine to machine (M2M) device which does not necessarily require human interactions to perform communications with another device.

20. The device of claim 18, wherein the feedback information comprises at least one of a channel quality indicator (CQI), a preferred matrix index (PMI), and a space time coding (STC).

21. The device of claim 18, wherein the feedback information comprises a MIMO feedback mode (MFM) bitmap which indicates a MIMO feedback mode to be used by the device.

22. The device of claim 21, wherein if a first least significant bit (LSB) is equal to “1” the feedback information further comprises a wideband channel quality indicator (CQI) which indicates an average value of CQIs across a whole band and a wideband space time coding (STC) which indicates a space time coding rate across the whole band.

23. The device of claim 21, wherein if a second least significant bit (LSB) is equal to “1” the feedback information further comprises a wideband channel quality indicator (CQI) which indicates an average value of CQIs across a whole band, a wideband space time coding (STC) which indicates a space timed coding rate across the whole band, and a wideband preferred matrix index (PMI) which indicates a preferred matrix index across the whole band.

24. A method of receiving feedback information by a base station in a wireless communication system, the method comprising:
receiving a ranging request message from a device which is a fixed station, the ranging request message comprising the feedback information which is to be used for a multiple input multiple output (MIMO) scheme; and
transmitting a ranging response message to the device in response to the ranging request message.

25. The method of claim 24, wherein the device is a machine to machine (M2M) device which does not necessarily require human interactions to perform communications with another device.

26. The method of claim 24, wherein the feedback information comprises at least one of a channel quality indicator (CQI), a preferred matrix index (PMI); and a space time coding (STC).

27. The method of claim 24, wherein the feedback information comprises a MIMO feedback mode (MFM) bitmap which indicates a MIMO feedback mode to be used by the device.

28. The method of claim 27, wherein if a first least significant bit (LSB) is equal to “1” the feedback information further comprises a wideband channel quality indicator (CQI) which indicates an average value of CQIs across a whole band and a wideband space time coding (STC) which indicates a space time coding rate across the whole band.

29. The method of claim 27, wherein if a second least significant bit (LSB) is equal to “1” the feedback information further comprises a wideband channel quality indicator (CQI) which indicates an average value of CQIs across a whole band, a wideband space time coding (STC) which indicates a space timed coding rate across the whole band, and a wideband preferred matrix index (PMI) which indicates a preferred matrix index across the whole band.

30. A base station for receiving feedback information in a wireless communication system, the device comprising:
a receiver configured to receive a ranging request message from a device which is a fixed station, the ranging request message comprising the feedback information which is to be used for a multiple input multiple output (MIMO) scheme, wherein the device is a fixed station; and
a transmitter configured to transmit a ranging response message to the device in response to the ranging request message.
